(19) United States
(12) Patent Application Publication
(10) Pub. No.: US 2016/0343281 A1
(43) Pub. Date: Nov. 24, 2016

(54) METHOD AND APPARATUS FOR RGB DATA CONVERSION

(71) Applicant: SHENZHEN CHINA STAR OPTOELECTRONICS TECHNOLOGY CO., LTD., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 14/422,355

(22) PCT Filed: Jan. 4, 2015
(86) PCT No.: PCT/CN2015/070064

§ 371 Date: Feb. 19, 2015

(30) Foreign Application Priority Data
Dec. 18, 2014 (CN) 201410802173.5

(51) Int. Cl. G09G 3/20

(52) U.S. Cl. CPC G09G 3/2003; G09G 2340/06

(57) ABSTRACT

A method for RGB data conversion includes the following steps: A) converting input values of RGB to an HSV color space; B) adjusting saturation values and/or brightness values on the condition that hue values of the HSV color space are unchanged; C) calculating color-enhanced values of RGB base on the hue vales, the saturation values and the brightness values after the step B). The present invention also provides an apparatus for RGB data conversion. In the method and apparatus for RGB data conversion of the present invention, the color quality of the display panel is improved by increasing the color saturation and/or brightness.

### FIELD OF THE INVENTION

The present invention relates to a method and an apparatus for RGB data conversion.

### BACKGROUND OF THE INVENTION

Currently, in a display device including a display panel for example a liquid crystal display (LCD) panel or an organic light emitting display (OLED) panel, a pixel is mostly comprised of a red (R) sub-pixel, a green (G) sub-pixel and a blue (B) sub-pixel. R data of the red sub-pixel, G data of the green sub-pixel and B data of the blue sub-pixel are controlled to mix the color for the display panel to display a color image. However, now because the display panel has a limited color gamut, the gorgeous color of the display panel is affected, thereby having poor color performance.

### SUMMARY

To overcome the above problem, the present invention provides a method for RGB data conversion. The method includes the following steps: A) converting input values of RGB to an HSV color space; B) adjusting saturation values and/or brightness values on the condition that hue values of the HSV color space are unchanged; C) calculating color-enhanced values of RGB base on the hue vales, the saturation values and the brightness values after the step B).

In the step B), the saturation values are adjusted by formula 1 and/or the brightness values are adjusted by formula 2.

$$\begin{matrix}{s}^{′} ( s ) = \frac{a \times ( 1 + a )}{{( s - 1 )}^{2} + a} - a & [ formula 1 ] \\ {v}^{′} ( v ) = \frac{b \times ( 1 + b )}{{( v - 1 )}^{2} + b} - b & [ formula 2 ]\end{matrix}$$

Wherein, a is a constant and a>0, b is a constant and b>0, s′ represents a saturation value after being adjusted, s represents an unadjusted saturation value, v′ represents a brightness value after being adjusted, v represents an unadjusted brightness value.

Further, if the saturation values and the brightness values are adjusted in the step B), the color-enhanced values of RGB are calculated by formula 3 in the step C).

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 3 ]$$

Wherein,

$${h}_{i} = [ \frac{h}{60} ] , \\ f = \frac{h}{60} - {h}_{i} ,$$

p=v′×(1−s′), q=v′×(1−f×s′), t=v′×(1−(1−f)×s′), h represents a hue value, s′ represents a saturation value after being adjusted, v′ represents a brightness value after being adjusted, R′ represents a color-enhanced value of R, G′ represents a color-enhanced value of G, B′ represents a color-enhanced value of B.

Further, if the saturation values are adjusted in the step B), the color-enhanced values of RGB are calculated by formula 4 in the step C).

$$( {R}^{′} , {G}^{′} , {B}^{′} ) = \{ \begin{matrix}( v , t , p ) & if {h}_{i} = 0 \\ ( q , v , p ) & if {h}_{i} = 1 \\ ( p , v , t ) & if {h}_{i} = 2 \\ ( p , q , v ) & if {h}_{i} = 3 \\ ( t , p , v ) & if {h}_{i} = 4 \\ ( v , p , q ) & if {h}_{i} = 5\end{matrix} \qquad [ formula 4 ]$$

Wherein,

$${h}_{i} = [ \frac{h}{60} ] , \\ f = \frac{h}{60} - {h}_{i} ,$$

p=v×(1−s′), q=v×(1−f×s′), t=v×(1−(1−f)×s′), h represents a hue value, s′ represents a saturation value after being adjusted, v represents an unadjusted brightness value, R′ represents a color-enhanced value of R, G′ represents a color-enhanced value of G, B′ represents a color-enhanced value of B.

Further, if the Further, if the brightness values are adjusted in the step B), the color-enhanced values of RGB are calculated by formula 5 in the step C).

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 5 ]$$

Wherein,

$${h}_{i} = [ \frac{h}{60} ] ,$$

p=v′×(1−s), q=v′×(1−f×s), t=v′×(1−(1−f)×s), h represents a hue value, s represents an unadjusted saturation value, v′ represents a brightness value after being adjusted, R′ represents a color-enhanced value of R, G′ represents a color-enhanced value of G, B′ represents a color-enhanced value of B.

Further, in the step A), the input values of RGB are converted to the HSV color space by formula 6.

$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$

Wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

The present invention also provides an apparatus for RGB data conversion. The apparatus includes a conversion unit, an adjusting unit and a calculating unit. The conversion unit is configured for converting input values of RGB to an HSV color space. The adjusting unit is configured for adjusting saturation values and/or brightness values on the condition that hue values of the HSV color space are unchanged. The calculating unit is configured for calculating color-enhanced values of RGB base on the hue vales, the saturation values and the brightness values processed by the adjusting unit.

Further, the adjusting unit is configured for adjusting the saturation values by formula 1 and/or for adjusting the brightness values by formula 2.

$$\begin{matrix}{s}^{′} ( s ) = \frac{a \times ( 1 + a )}{{( s - 1 )}^{2} + a} - a & [ formula 1 ] \\ {v}^{′} ( v ) = \frac{b \times ( 1 + b )}{{( v - 1 )}^{2} + b} - b & [ formula 2 ]\end{matrix}$$

Wherein, a is a constant and a>0, b is a constant and b>0, s′ represents a saturation value after being adjusted, s represents an unadjusted saturation value, v′ represents a brightness value after being adjusted, v represents an unadjusted brightness value.

Further, if the adjusting unit is configured for adjusting the saturation values and the brightness values, the calculating unit is used for calculating the color-enhanced values of RGB by formula 3.

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 3 ]$$

Wherein,

$${h}_{i} = [ \frac{h}{60} ] , \\ f = \frac{h}{60} - {h}_{i} ,$$

p=v′×(1−s′), q=v′×(1−f×s′), t=v′×(1−(1−f)×s′), h represents a hue value, s′ represents a saturation value after being adjusted, v′ represents a brightness value after being adjusted, R′ represents a color-enhanced value of R, G′ represents a color-enhanced value of G, B′ represents a color-enhanced value of B.

Further, if the adjusting unit is configured for adjusting the saturation values, the calculating unit is used for calculating the color-enhanced values of RGB by formula 4.

$$( {R}^{′} , {G}^{′} , {B}^{′} ) = \{ \begin{matrix}( v , t , p ) & if {h}_{i} = 0 \\ ( q , v , p ) & if {h}_{i} = 1 \\ ( p , v , t ) & if {h}_{i} = 2 \\ ( p , q , v ) & if {h}_{i} = 3 \\ ( t , p , v ) & if {h}_{i} = 4 \\ ( v , p , q ) & if {h}_{i} = 5\end{matrix} \qquad [ formula 4 ]$$

Wherein,

$${h}_{i} = [ \frac{h}{60} ] , \\ f = \frac{h}{60} - {h}_{i} ,$$

p=v×(1−s′), q=v×(1−f×s′), t=v×(1−(1−f)×s′), h represents a hue value, s′ represents a saturation value after being adjusted, v represents an unadjusted brightness value, R′ represents a color-enhanced value of R, G′ represents a color-enhanced value of G, B′ represents a color-enhanced value of B.

Further, if the adjusting unit is configured for adjusting the brightness values, the calculating unit is used for calculating the color-enhanced values of RGB by formula 5.

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 5 ]$$

Wherein,

$${h}_{i} = [ \frac{h}{60} ] ,$$

p=v′×(1−s), q=v′×(1−f×s), t=v′×(1−(1−f)×s), h represents a hue value, s represents an unadjusted saturation value, v′ represents a brightness value after being adjusted, R′ represents a color-enhanced value of R, G′ represents a color-enhanced value of G, B′ represents a color-enhanced value of B.

Further, the conversion unit converts the input values of RGB to the HSV color space by formula 6.

$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$

Wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

In the method and apparatus for RGB data conversion of the present invention, the color quality of the display panel is improved by increasing the color saturation and/or brightness.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a block diagram of a display device in accordance with an embodiment of the present invention.

FIG. 2 illustrates a schematic view of a display panel in accordance with an embodiment of the present invention.

FIG. 3 illustrates a principle block diagram of an apparatus for RGB data conversion in accordance with an embodiment of the present invention.

FIG. 4 illustrates a flow chart of a method for RGB data conversion in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

In the present embodiment, a display device can be, for example, a liquid crystal display (LCD), an organic light emitting display (OLED), and so on.

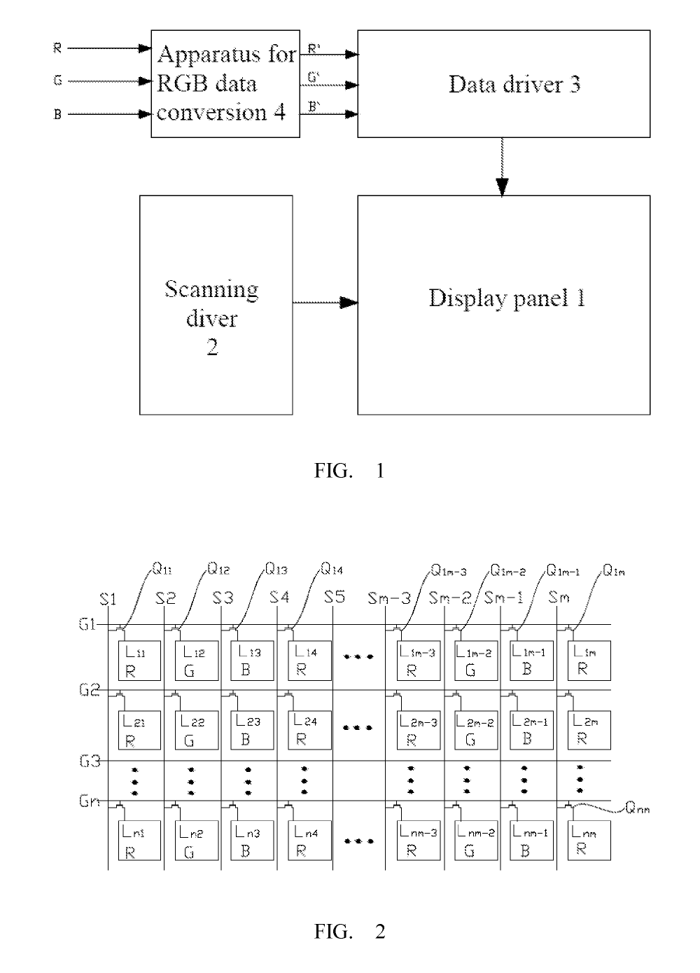

FIG. 1 illustrates a block diagram of a display device in accordance with an embodiment of the present invention. FIG. 2 illustrates a schematic view of a display panel in accordance with an embodiment of the present invention.

Referring to FIG. 1 and FIG. 2, in the present embodiment, the display device includes a display panel 1, a scanning diver 2, a data driver 3 and an apparatus for RGB data conversion 4.

The display panel 1 includes a number of scanning lines G1 to Gm (wherein m is a natural number) extending along a row direction and a number of data lines S1 to Sn (wherein n is a natural number) extending along a column direction. The scanning G1 to Gm are connected to the scanning driver 2, the data lines S1 to Sn are connected to the data driver 3.

A sub-pixel Lij (a red (R) sub-pixel, a green (G) sub-pixel or a blue (B) sub-pixel) is located in a region defined by the scanning lines Gi, Gi+1 (wherein, i is from 1 to m) and data lines Sj, Sj+1 (wherein, j is from 1 to n). One red (R) sub-pixel, one green (G) sub-pixel and one blue (B) sub-pixel constitute a pixel.

Thin film transistor (TFT) Qij is disposed near a cross point of the scanning line Gi and the data line Sj.

Further, the scanning line Gi is connected to a gate of the thin film transistor Qij, the data line Sj is connected to a source electrode of the thin film transistor Qij, the pixel electrode of the sub-pixel Lij (a red (R) sub-pixel, a green (G) sub-pixel or a blue (B) sub-pixel) is connected to a drain electrode of the thin film transistor Qij. A common electrode opposite to the pixel electrode of the sub-pixel Lij is connected to a common voltage circuit (not shown).

The scanning driver 2 and the data driver 3 are disposed around the display panel 1. The apparatus for RGB data conversion 4 converts input values of RGB to color-enhanced values of RGB, and sends the color-enhanced values of RGB to the data driver 3. The input values of RGB can be provided by, for example, an exterior host or a graphic controller (not shown).

The data driver 3 receives and processes the color-enhanced values of RGB from the apparatus for RGB data conversion 4 so as to generate a number of analogous data signals to the data lines S1 to Sn. The scanning driver 2 provides a number of scanning signals to the scanning lines G1 to Gm. The display panel 1 displays an image according to the analogous data signals from the data driver 3 and the scanning signals from the scanning driver 2.

The apparatus for RGB data conversion 4 of the present embodiment will be described in detail in the following description.

FIG. 3 illustrates a principle block diagram of an apparatus for RGB data conversion in accordance with an embodiment of the present invention.

Referring to FIG. 3, the apparatus for RGB data conversion 4 of the present embodiment includes a conversion unit 41, an adjusting unit 42 and a calculating unit 43. The conversion unit 41 is configured for converting input values of RGB to an HSV (hue, saturation, value) color space. The adjusting unit 42 is configured for adjusting saturation values and/or brightness values on the condition that hue values of the HSV color space are unchanged. In other words, the adjusting unit 42 is configured for processing the hue values, the saturation values and the brightness values. The calculating unit 43 is configured for calculating color-enhanced values of RGB base on the hue vales, the saturation values and the brightness values processed by the adjusting unit 42.

In detail, the conversion unit 41 can convert the input values of RGB to the HSV color space by formula 6.

$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$

Wherein, r represents an input value of R, g represents an input value of G, b represents an input value of B, max represents a maximum value of r, g, b, min represents a minimum value of r, g, b, h represents a hue value before being adjusted (that is, the hue value is not processed by the adjusting unit 42 when the input values of RGB are converted to the HSV color space), s represents an unadjusted saturation value (that is, the saturation value is not processed by the adjusting unit 42 when the input values of RGB are converted to the HSV color space), v represents an unadjusted brightness value (that is, the brightness value is not processed by the adjusting unit 42 when the input values of RGB are converted to the HSV color space),

The adjusting unit 42 can adjust the saturation values by formula 1 and/or for adjusting the brightness values by formula 2 on the condition that hue values of the HSV color space are unchanged.

$$\begin{matrix}{s}^{′} ( s ) = \frac{a \times ( 1 + a )}{{( s - 1 )}^{2} + a} - a & [ formula 1 ] \\ {v}^{′} ( v ) = \frac{b \times ( 1 + b )}{{( v - 1 )}^{2} + b} - b & [ formula 2 ]\end{matrix}$$

Wherein, a is a constant and a>0, b is a constant and b>0, s′ represents a saturation value after being adjusted, s represents an unadjusted saturation value, v′ represents a brightness value after being adjusted, v represents an unadjusted brightness value.

It can be understood that, the adjusting unit 42 in the present embodiment can be configured for only adjusting the saturation values by formula 1, or for only adjusting the brightness values by formula 2, or for adjusting both the saturation values by formula 1 and the brightness values by formula 2. In other words, when the adjusting unit 42 only adjusts the saturation values by formula 1, the hue values and the brightness values of the HSV color space are unchanged. When the adjusting unit 42 only adjusts the brightness values by formula 1, the hue values and the saturation values of the HSV color space are unchanged. When the adjusting unit 42 adjusts the saturation values by formula 1 and the brightness values by formula 2, the hue values of the HSV color space are unchanged. That is, the adjusting unit 42 can adjust the saturation values by formula 1 and/or the brightness values by formula 2 on the condition that hue values of the HSV color space are unchanged.

If the adjusting unit 42 is configured for adjusting the by formula 1 and for adjusting the brightness values by formula 2, the calculating unit 43 is configured for calculating the color-enhanced values of RGB by formula 3.

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ [ formula 3 ]$$

Wherein,

$${h}_{i} = [ \frac{h}{60} ] , f = \frac{h}{60} - {h}_{i} ,$$

p=v′×(1−s′), q=v′×(1−f×s′), t=v′×(1−(1−f)×s′), h represents a hue value, s′ represents a saturation value after being adjusted, v′ represents a brightness value after being adjusted, R′ represents a color-enhanced value of R, G′ represents a color-enhanced value of G, B′ represents a color-enhanced value of B.

If the adjusting unit 42 is only configured for adjusting the by formula 1, the calculating unit 43 is configured for calculating the color-enhanced values of RGB by formula 4.

$$( {R}^{′} , {G}^{′} , {B}^{′} ) = \{ \begin{matrix}( v , t , p ) & if {h}_{i} = 0 \\ ( q , v , p ) & if {h}_{i} = 1 \\ ( p , v , t ) & if {h}_{i} = 2 \\ ( p , q , v ) & if {h}_{i} = 3 \\ ( t , p , v ) & if {h}_{i} = 4 \\ ( v , p , q ) & if {h}_{i} = 5\end{matrix} \qquad [ formula 4 ]$$

Wherein,

$${h}_{i} = [ \frac{h}{60} ] , f = \frac{h}{60} - {h}_{i} ,$$

p=v×(1−s′), q=v×(1−f×s′), t=v×(1−(1−f)×s′), h represents a hue value, s′ represents a saturation value after being adjusted, v represents an unadjusted brightness value, R′ represents a color-enhanced value of R, G′ represents a color-enhanced value of G, B′ represents a color-enhanced value of B.

If the adjusting unit 42 is only configured for adjusting the brightness values by formula 2, the calculating unit 43 is configured for calculating the color-enhanced values of RGB by formula 5.

$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 5 ]$$

Wherein,

$${h}_{i} = [ \frac{h}{60} ] ,$$

p=v′λ(1−s), q=v′×(1−f×s), t=v′×(1−(1−f)×s), h represents a hue value, s represents an unadjusted saturation value, v′ represents a brightness value after being adjusted, R′ represents a color-enhanced value of R, G′ represents a color-enhanced value of G, B′ represents a color-enhanced value of B.

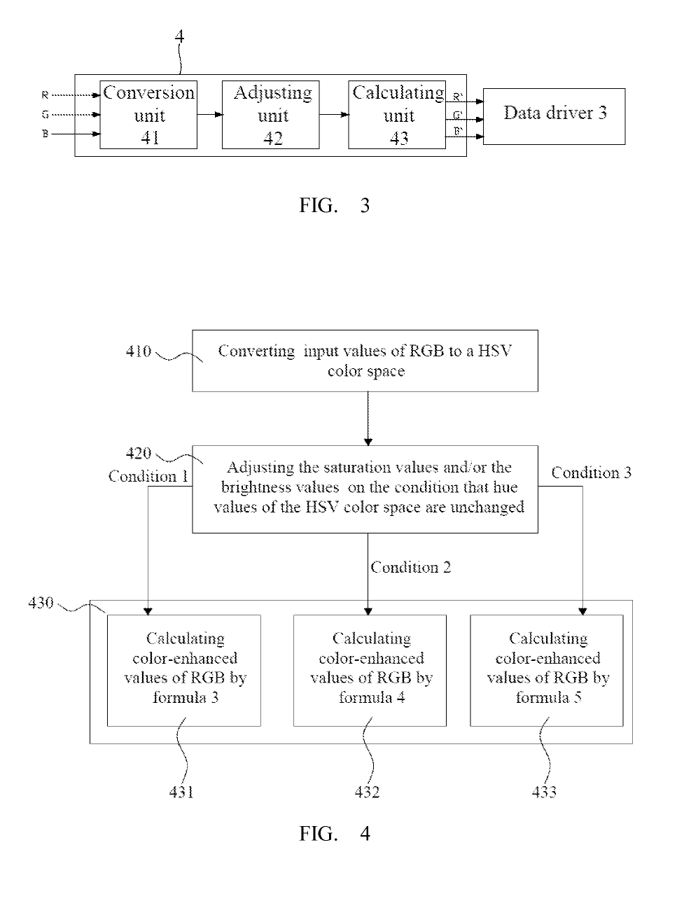

FIG. 4 illustrates a flow chart of a method for RGB data conversion in accordance with an embodiment of the present invention.

Referring to FIG. 4, in step 410, converting the input values of RGB to the HSV color space is performed. In the step 410, the input values of RGB are converted to the HSV color space by formula 6.

In step 420, adjusting the saturation values and/or the brightness values is performed on the condition that hue values of the HSV color space are unchanged. In the step 420, the saturation values are adjusted by formula 1 and/or the brightness values are adjusted by formula 2. It can be understood that, in the step 420, only the saturation values are adjusted by formula 1, or only the brightness values are adjusted by formula 2, or both the saturation values are adjusted by formula 1 and the brightness values are adjusted by formula 2. In other words, when only the saturation values are adjusted by formula 1, the hue values and the brightness values of the HSV color space are unchanged. When only the brightness values are adjusted by formula 1, the hue values and the saturation values of the HSV color space are unchanged. When both the saturation values are adjusted by formula 1 and the brightness values are adjusted by formula 2, the hue values of the HSV color space are unchanged. That is, the saturation values can be are adjusted by formula 1 and/or the brightness values can be are adjusted by formula 2 on the condition that hue values of the HSV color space are unchanged.

In step 430, calculating color-enhanced values of RGB base on the hue vales, the saturation values and the brightness values after the step 420 is perfumed. In the step 430, the calculating method of the color-enhanced values of RGB is described in the following description.

In the step 420, if the saturation values are adjusted by formula 1 and the brightness values are adjusted by formula 2 (i.e., condition 1 in FIG. 4), step 431 is performed. In the step 431, the color-enhanced values of RGB are calculated by formula 3.

In the step 420, if only the saturation values are adjusted by formula 1 (i.e., condition 2 in FIG. 4), step 432 is performed. In the step 432, the color-enhanced values of RGB are calculated by formula 4.

In the step 420, if only the brightness values are adjusted by formula 2 (i.e., condition 3 in FIG. 4), step 433 is performed. In the step 433, the color-enhanced values of RGB are calculated by formula 5.

In summary, according to the method and apparatus for RGB data conversion of the present invention, the color quality of the display panel is improved by increasing the color saturation and/or brightness.

While the invention has been descry bed in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for RGB data conversion, comprising the following steps:
A) converting input values of RGB to an HSV color space;
B) adjusting saturation values and/or brightness values on the condition that hue values of the HSV color space are unchanged; and
C) calculating color-enhanced values of RGB base on the hue vales, the saturation values and the brightness values after the step B).

2. The method as claimed in claim 1, wherein in the step B) the saturation values are adjusted by formula 1 and/or the brightness values are adjusted by formula 2,
$$\begin{matrix}{s}^{′} ( s ) = \frac{a \times ( 1 + a )}{{( s - 1 )}^{2} + a} - a & [ formula 1 ] \\ {v}^{′} ( v ) = \frac{b \times ( 1 + b )}{{( v - 1 )}^{2} + b} - b & [ formula 2 ]\end{matrix}$$
wherein, a is a constant and a>0, b is a constant and b>0, s′ represents a saturation value after being adjusted, s represents an unadjusted saturation value, v′ represents a brightness value after being adjusted, v represents an unadjusted brightness value.

3. The method as claimed in claim 2, wherein in the step B) if the saturation values and the brightness values are adjusted, the color-enhanced values of RGB are calculated by formula 3 in the step C),
$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 3 ]$$
wherein,
$${h}_{i} = [ \frac{h}{60} ] , f = \frac{h}{60} - {h}_{i} ,$$
p=v′×(1−s′), q=v′×(1−f×s′), t=v′×(1−(1−f)×s′), h represents a hue value, s′ represents a saturation value after being adjusted, v′ represents a brightness value after being adjusted, R′ represents a color-enhanced value of R, G′ represents a color-enhanced value of G, B′ represents a color-enhanced value of B.

4. The method as claimed in claim 2, wherein in the step B) if the saturation values are adjusted, the color-enhanced values of RGB are calculated by formula 4 in the step C),
$$( {R}^{′} , {G}^{′} , {B}^{′} ) = \{ \begin{matrix}( v , t , p ) & if {h}_{i} = 0 \\ ( q , v , p ) & if {h}_{i} = 1 \\ ( p , v , t ) & if {h}_{i} = 2 \\ ( p , q , v ) & if {h}_{i} = 3 \\ ( t , p , v ) & if {h}_{i} = 4 \\ ( v , p , q ) & if {h}_{i} = 5\end{matrix} \qquad [ formula 4 ]$$
wherein,
$${h}_{i} = [ \frac{h}{60} ] , f = \frac{h}{60} - {h}_{i} ,$$
p=v×(1−s′), q=v×(1−f×s′), t=v×(1−(1−f)×s′), h represents a hue value, s′ represents a saturation value after being adjusted, v represents an unadjusted brightness value, R′ represents a color-enhanced value of R, G′ represents a color-enhanced value of G, B′ represents a color-enhanced value of B.

5. The method as claimed in claim 2, wherein in the step B) if the brightness values are adjusted, the color-enhanced values of RGB are calculated by formula 5 in the step C),
$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 5 ]$$
wherein,
$${h}_{i} = [ \frac{h}{60} ] ,$$
p=v′×(1−s), q=v′×(1−f×s), t=v′×(1−(1−f)×s), h represents a hue value, s represents an unadjusted saturation value, v′ represents a brightness value after being adjusted, R′ represents a color-enhanced value of R, G′ represents a color-enhanced value of G, B′ represents a color-enhanced value of B.

6. The method as claimed in claim 3, wherein in the step A) the input values of RGB are converted to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

7. The method as claimed in claim 4, wherein in the step A) the input values of RGB are converted to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

8. The method as claimed in claim 5, wherein in the step A) the input values of RGB are converted to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

9. An apparatus for RGB data conversion, comprising:
a conversion unit configured for converting input values of RGB to an HSV color space;
an adjusting unit configured for adjusting saturation values and/or brightness values on the condition that hue values of the HSV color space are unchanged; and
a calculating unit configured for calculating color-enhanced values of RGB base on the hue vales, the saturation values and the brightness values processed by the adjusting unit.

10. The apparatus as claimed in claim 9, wherein the adjusting unit is configured for adjusting the saturation values by formula 1 and/or for adjusting the brightness values by formula 2,
$$\begin{matrix}{s}^{′} ( s ) = \frac{a \times ( 1 + a )}{{( s - 1 )}^{2} + a} - a & [ formula 1 ] \\ {v}^{′} ( v ) = \frac{b \times ( 1 + b )}{{( v - 1 )}^{2} + b} - b & [ formula 2 ]\end{matrix}$$
wherein, a is a constant and a>0, b is a constant and b>0, s′ represents a saturation value after being adjusted, s represents an unadjusted saturation value, v′ represents a brightness value after being adjusted, v represents an unadjusted brightness value.

11. The apparatus as claimed in claim 10, wherein if the adjusting unit is configured for adjusting the saturation values and the brightness values, the calculating unit is configured for calculating the color-enhanced values of RGB by formula 3,
$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 3 ]$$
wherein,
$${h}_{i} = [ \frac{h}{60} ] , f = \frac{h}{60} - {h}_{i} ,$$
p=v′×(1−s), q=v′×(1−f×s′), t=v′×(1−(1−f)×s′) h represents a hue value, s′ represents a saturation value after being adjusted, v′ represents a brightness value after being adjusted, R′ represents a color-enhanced value of R, G′ represents a color-enhanced value of G, B′ represents a color-enhanced value of B.

12. The apparatus as claimed in claim 10, wherein if the adjusting unit is configured for adjusting the saturation values, the calculating unit is configured for calculating the color-enhanced values of RGB by formula 4,
$$( {R}^{′} , {G}^{′} , {B}^{′} ) = \{ \begin{matrix}( v , t , p ) & if {h}_{i} = 0 \\ ( q , v , p ) & if {h}_{i} = 1 \\ ( p , v , t ) & if {h}_{i} = 2 \\ ( p , q , v ) & if {h}_{i} = 3 \\ ( t , p , v ) & if {h}_{i} = 4 \\ ( v , p , q ) & if {h}_{i} = 5\end{matrix} \qquad [ formula 4 ]$$
wherein,
$${h}_{i} = [ \frac{h}{60} ] , f = \frac{h}{60} - {h}_{i} ,$$
p=v×(1−s′), q=v×(1−f×s′), t=v×(1−(1−f)×s′), h represents a hue value, s′ represents a saturation value after being adjusted, v represents an unadjusted brightness value, R′ represents a color-enhanced value of R, G′ represents a color-enhanced value of G, B′ represents a color-enhanced value of B.

13. The apparatus as claimed in claim 10, wherein if the adjusting unit is configured for adjusting the brightness values, the calculating unit is configured for calculating the color-enhanced values of RGB by formula 5,
$$( {R}^{′} , {G}^{′} , {B}^{′} ) = \{ \begin{matrix}( {v}^{′} , t , p ) & if {h}_{i} = 0 \\ ( q , {v}^{′} , p ) & if {h}_{i} = 1 \\ ( p , {v}^{′} , t ) & if {h}_{i} = 2 \\ ( p , q , {v}^{′} ) & if {h}_{i} = 3 \\ ( t , p , {v}^{′} ) & if {h}_{i} = 4 \\ ( {v}^{′} , p , q ) & if {h}_{i} = 5\end{matrix} \qquad [ formula 5 ]$$
wherein,
$${h}_{i} = [ \frac{h}{60} ] ,$$
p=v′×(1−s), q=v′×(1−f×s), t=v′×(1−(1−f)×s), h represents a hue value, s represents an unadjusted saturation value, v′ represents a brightness value after being adjusted, R′ represents a color-enhanced value of R, G′ represents a color-enhanced value of G, B′ represents a color-enhanced value of B.

14. The apparatus as claimed in claim 11, wherein the conversion unit converts the input values of RGB to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

15. The apparatus as claimed in claim 12, wherein the conversion unit converts the input values of RGB to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.

16. The apparatus as claimed in claim 13, wherein the conversion unit converts the input values of RGB to the HSV color space by formula 6,
$$h = \{ \begin{matrix}0 ° & if max = min \\ 60 ° \times \frac{g - b}{max - min} + 0 ° & if max = r and g \geq b \\ 60 ° \times \frac{g - b}{max - min} + 360 ° & if max = r and g < b \\ 60 ° \times \frac{b - r}{max - min} + 120 ° & if max = g \\ 60 ° \times \frac{r - g}{max - min} + 240 ° & if max = b\end{matrix} \\ s = \{ \begin{matrix}0 & if max = 0 \\ \frac{max - min}{max} = 1 - \frac{min}{max} & other\end{matrix} \\ v = max \qquad [ formula 6 ]$$
wherein, r represents an input value of R, g represents an input value of G, b represents an input value of B, max represents a maximum value of r, g, b, min represents a minimum value of r, g, b, h represents a hue value before being adjusted, s represents an unadjusted saturation value, v represents an unadjusted brightness value.
